(19) United States
(12) Patent Application Publication
(10) Pub. No.: US 2010/0096413 A1
(43) Pub. Date: Apr. 22, 2010

(54) Liquid Dispenser

(75) Inventor: Amir Genosar, Lafayette, CO (US)

Correspondence Address: WILLIAM L. FALK;Andrus, Sceales, Starke & Sawall, Suite 1100, 100 East Wisconsin Avenue, Milwaukee, WI, 53202, US

(73) Assignee: Profile Dispensing Innovation, LLC, Lafayette, CO (US)

(21) Appl. No.: 12/642,146

(22) Filed: Dec. 18, 2009

Related U.S. Application Data
(63) Continuation of application No. 10/514,225, filed on Jun. 8, 2005, now abandoned.

(30) Foreign Application Priority Data
May 15, 2002 (IL) 149,677

(51) Int. Cl. B65D 37/00

(52) U.S. Cl. 222/207

(57) ABSTRACT

The invention provides a liquid dispenser 2 comprising a mostly rigid body including two spaced-apart major surfaces 8 and 10 having interconnected peripheral edges 12 to delimit there between a closed dispensing body having a liquid to be dispensed contained therein, a pumping chamber 5 having an inlet valves 6 and a non-return product dispensing valve 7 and actuated by a pumping button 9 provided along one of the major surfaces 10 and displaceable between a first normal position and a second expressed position, the arrangement being such that the dispenser is formed as a compact, self-contained unitary container and pump, wherein said pumping button 9 is formed as an integral part of one of said major surfaces 10 and serves as a wall of said pumping chamber 5, and depression of the pumping button 9 to its displaced position causes liquid contained in the pumping chamber 5 to be expelled via the product dispensing valve 7, and return of the button to its first normal position causes liquid to enter the pumping chamber 5 via the inlet valve 6.

### FIELD OF THE INVENTION

The present invention relates to the field of dispensers and packaging. More specifically, the present invention relates to a rigid hand-held container for the controlled dispensing of liquid products, either as a spray or in a liquid form wherein said dispenser is formed as a compact, self-contained unitary container and pump with integral valve means.

### BACKGROUND OF THE INVENTION

Whereas jars and cans were once the staple of the packaging industry, in recent years many forms of dispensing package have now become popular for almost all forms of foods and cosmetics. The basic concept behind the dispensing package is that, instead of the consumer having to reach inside with a knife, spoon or hand to extract the contents, by pressing on the package itself a certain portion of the contents is dispensed. Current dispensing packaging systems employ either (a) a dispensing pump mounted in connection to a rigid package, or (b) a flexible package with a dispensing closure. Dispensing pumps are often used for products such as liquid soaps and perfume sprays, depending on the type of nozzle employed. In restaurants they are also used for sauces such as ketchup. Flexible packages with dispensing closures are typically used for food products such as ketchup and mustard, where squeezing the package causes the food product to emanate via a hole in the dispensing closure. Other applications for this type of package include toothpaste and various cremes.

For controlled dosing, flexible packaging provides a very poor solution. On the other hand, whereas dispensing pumps allow good control over flow and have the pleasing tactile sensation associated with pressing a button, they are complicated and expensive to implement. Additionally, they are not generally suitable for hand-held operation. Despite this the prior art does contain some examples of attempts to make simple hand-held dispensing packages, especially for perfume sprays. For example, U.S. Pat. No. 5,492,248, describes a hand-held cylindrical perfume dispenser in the form factor of a pencil. Due to this convenient shape, the dispenser can be held in the palm of the hand while one finger of that hand depresses a pump actuator mounted at one end. However, this is a complicated and expensive product to produce, and unsuitable for stacking or incorporation in flat packaging and magazines. Another example of a package enabling hand-held operation is described in U.S. Pat. No. 5,950,871 and U.S. Pat. No. 6,021,930. This dispenser, also in the perfume field, is a slight improvement on the flexible packaging concept and comprises a container where the two sides of the container are squeezed together in order to spray the contents. However, this design lacks a pumping button action and would be impractical to stack as the pressure on the sides would cause the liquid product contained within to leak out. Thus there exists a need for a hand-held dispenser capable of containing a liquid product which may be of viscosity ranging from pure liquid such as perfume to pasty materials such as toothpaste, shoe polish or creams, which is actuated by a press button but has a rigid structure.

It is therefore the object of this invention to provide a rigid, hand-held container enabling easy pump dispensing of its contents.

It is also the object of the present invention to enable a number of container depths so as to enable different volumes to be stored, where a slim-line version is suitable for distribution of samples of the contents by mail or magazine.

It is furthermore the object of the present invention to enable simple and inexpensive fabrication of said containers based around an injected plastic part covered on both sides.

These and other objects of this invention will become more evident in the summary of the invention and in the description of the preferred embodiment.

### SUMMARY OF THE INVENTION

According to the present invention there is now provided a liquid dispenser comprising a mostly rigid body including two spaced-apart major surfaces having interconnected peripheral edges to delimit there between a closed dispensing body having a liquid to be dispensed contained therein, a pumping chamber having an inlet valve and a non-return product dispensing valve and actuated by a pumping button provided along one of said surfaces and displaceable between a first normal position and a second depressed position, the arrangement being such that said dispenser is formed as a compact, self-contained unitary container and pump, wherein said pumping button is formed as an integral part of one of said major surfaces and serves as a wall of said pumping chamber, and depression of the pumping button to its displaced position causes liquid contained in said pumping chamber to be expelled via said product dispensing valve and return of said button to its first normal position causes liquid to enter said pumping chamber via said inlet valve.

In preferred embodiments of the present invention said liquid dispenser further comprises an uptake tube in fluid communication with said inlet valve and positioned to deliver liquid to said pumping chamber upon return of said pumping button to its first pumping position.

In further preferred embodiment of the present invention said dispenser further comprises a non-return pressure-compensation valve leading into said body.

In said embodiments return of said button to its first normal position transfers said liquid from said tube to said pumping chamber which in turn forces liquid from said body into said uptake tube and causes air to enter said body via said pressure-compensation valve.

As will be realized the present invention relates to a packaging system offering greater convenience and different form factors than those provided by existing systems. The dispenser of the current invention consists of an injection-molded plastic spine, attached to two panels (which constitute the front and back surfaces of the package). The liquid contents of the package are stored in the space between the spine and the panels. The front panel has a push button inset into it, such that the top of the button is approximately flush with the rest of the panel. This button serves to pump out the liquid contents of the dispenser of the present invention in measured doses. The pressure resulting from the depression of the button causes the liquid in the pump chamber to be forced out of the outlet valve, where it exits via the nozzle connected to this valve. When the button is released, said button is arranged to regain its former position or shape, either do to a spring action or do to the button's internal structural stress. This causes low pressure within the package, which in turn causes the liquid contents to fill up the pumping chamber through the intake tube via the inlet valve and air to enter the compensation valve to equalize the pressure. The incoming air refills the uptake tube so the process can be repeated.

In a preferred embodiment of the invention, the button is a thermoformed section of the front panel, and thus the total parts count is kept at a minimum. In a further preferred embodiment, the valves and nozzle are all part of one injected plastic part (the “spine” of the device).

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

The invention is herein described, by way of example only, with reference to the accompanying drawings, wherein:

FIG. 1 illustrates the main components of the dispensing closure of the current invention, FIG. 1a being an elevational view, FIG. 1b being a section taken at AA, FIG. 1c being a perspective view and FIG. 1d being an enlargement of part of FIG. 1c;

FIG. 2 is an elevational view of a preferred embodiment of the dispensing closure, FIG. 2a is an enlarged sectional view taken at BB and FIG. 2b being an enlarged portion of FIG. 2a;

FIG. 3b is an enlarged cross-sectional view taken at CC of FIG. 3a, to provide a further cross-sectional view of the dispensing closure, demonstrating the structural support of the spine afforded to the front and rear panels;

FIG. 4a is a perspective view illustrating the construction of a valve as an injection-molded part, while FIG. 4b is a cross-sectional view thereof;

FIGS. 5 through 7 portray the pump and valve elements of a preferred embodiment of the dispensing package, illustrating the mechanism of the fluid flow through the package; wherein

FIG. 5 shows the valves in a closed position (prior to pumping),

FIG. 6 shows the position of the valves during the pumping action, and

FIG. 7 shows the position of the valves after the pumping action;

FIGS. 8a and 8b are sectional views illustrating an alternative embodiment of the valve structure, utilizing a spring and ball design;

FIGS. 9a and 9b are sectional views illustrating an alternative embodiment of the valve structure using a flexible strip design;

FIGS. 10a and 10b are sectional views illustrating a further alternative embodiment of the valve structure using a bow-shaped plastic spring;

FIGS. 11a and 11b are sectional views illustrating a single-piece plastic valve and how it is molded;

FIGS. 12a and 12b are cross-sectional views showing a cantilever structure valve and its implementation in the dispensing package of the current invention,

FIG. 13 illustrates a two-valve embodiment of the dispensing package where the need for a pressure-compensation valve is obviated by the use of an internal bag, which contracts;

FIGS. 14a, b, and c illustrate an alternate embodiment of the button mechanism;

FIG. 15a is a side view, and FIG. 15 b an enlargement of a part thereof illustrating the use of higher sidewalls so as to implement a larger volume-dispensing package;

FIGS. 16a and 16b are perspective views illustrating the addition of a fold-out spout in place of the nozzle, for dispensing liquids and condiments, and

FIGS. 17a and 17b are sectional views of a valve, closed in 17a and open in 17b, constructed to operate by movement of a sealing element in a direction perpendicular to the spaced-apart major surfaces.

### DETAILED DESCRIPTION OF THE DRAWINGS

The present invention will be described in detail according to the preferred embodiments illustrated in the accompanying drawings. Like reference numerals are used to identify identical components in the various views.

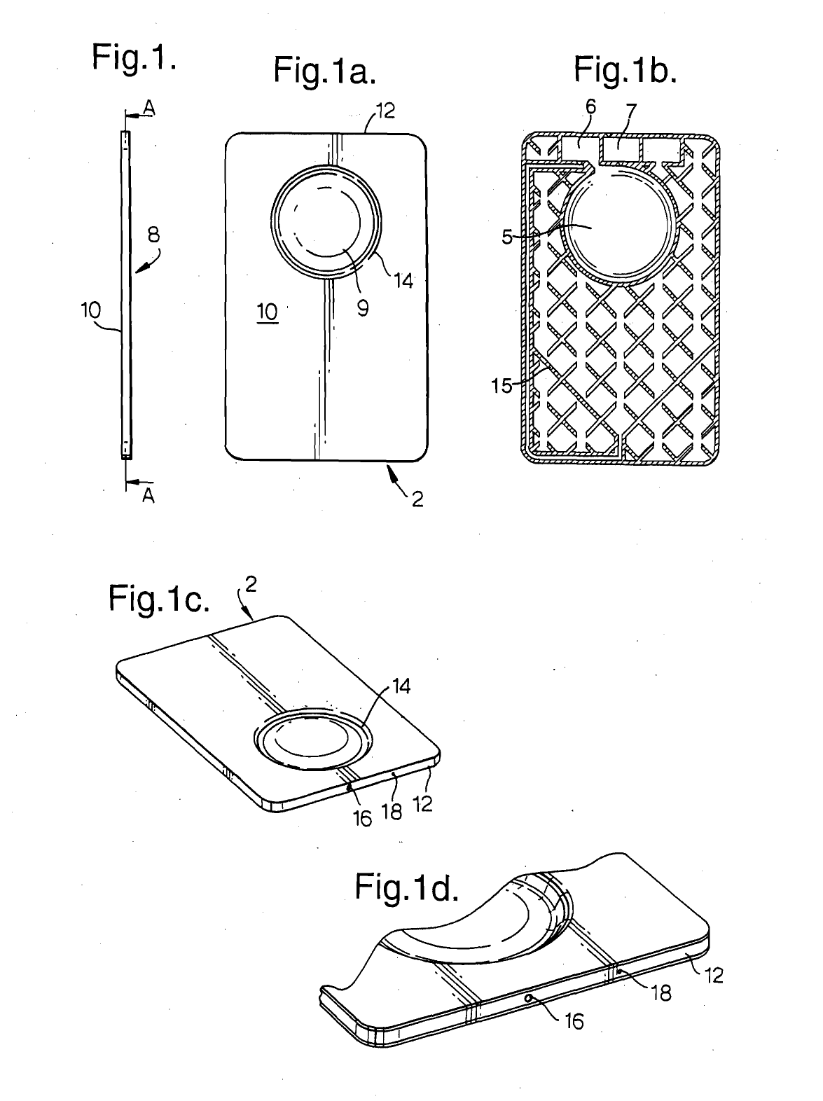

Referring to FIG. 1, an overview of a preferred embodiment of the dispensing package is shown, whereby FIG. 1a shows a finished fabricated device shaped like a credit card with the front panel 10 in place. FIG. 1b shows said front panel cut-away to reveal the general structure of the underlying spine 15 of said dispensing package. Said spine is designed as an open network of supports providing structural strength to the front and back panels and thus to the dispenser as a whole. In a preferred embodiment of the dispenser, the spine 15 is made of injection-molded plastic. While several plastics are suitable, high molecular weight PE and SAN (styrene-acrylonitrile) is preferred. In a further embodiment of the dispenser, the dimensions of the dispenser are similar to those of a credit card and this is advantageous in terms of convenience of storage and carrying together with an individual's personal effects. The end of the device 12 nearer the button area 14 contains the valve mechanisms described below, where the external elements of said mechanism are shown in FIGS. 1c and 1d as a spray nozzle 16 and an air inlet 18. As will be obvious to one skilled in the art, a number of potential outlet nozzles may be used with such a dispenser, and a spray nozzle is just one possible embodiment.

It will be realized that liquids with the ability to penetrate plastics, including volatile fluids and oils can be sealed in the dispenser in an improved manner by extending the front and rear panels to meet each other and joining the edges together. The spray nozzle 16 is then exposed for use when a consumer tears off a seal covering said nozzle.

It is further possible to reduce possible long-term leakage of the dispenser by extending the front and back panels around at least some edges of the spine 15. For ease of fabrication, in an alternative embodiment, said panels can be implemented as one contiguous surface surrounding the spine

More specifically, referring to FIGS. 1b and 1c there is seen a liquid dispenser 2 comprising a mostly rigid body including two spiced-apart major surfaces 8 and 10 having interconnected peripheral edges 12 to delimit there between a closed dispensing body having a liquid to be dispensed contained therein, a pumping chamber 5 having an inlet valve 6 and a non-return product dispensing valve 7 and actuated by a pumping button 9 provided along one of the major surfaces 10 and displaceable between a first normal position and a second depressed position, the arrangement being such that the dispenser is formed as a compact, self-contained unitary container and pump, wherein said pumping button 9 is formed as an integral part of one of said major surfaces 10 and serves as a wall of said pumping chamber 5, and depression of the pumping button 9 to its displaced position causes liquid contained in the pumping chamber 5 to be expelled via the product dispensing valve 7, and return of the button to its first normal position causes liquid to enter the pumping chamber 5 via the inlet valve 6.

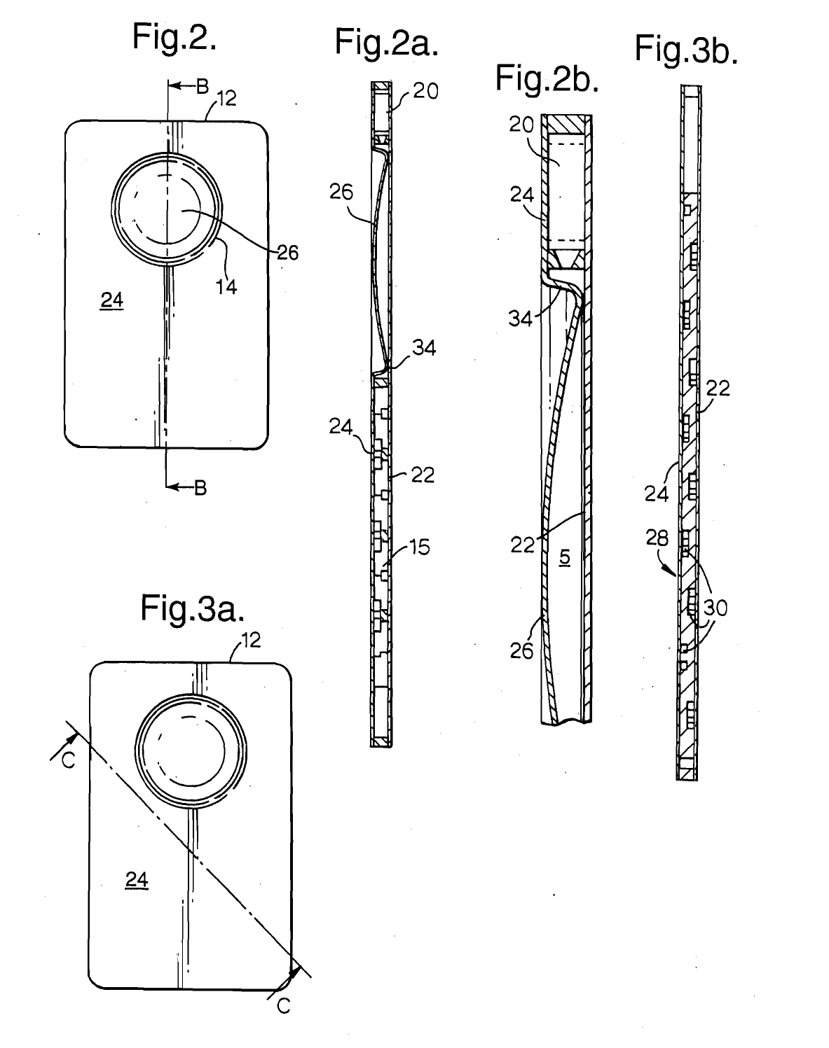

Referring now to FIG. 2, a cross-section of a preferred embodiment of the dispensing package of the present invention is shown in FIG. 2a. The area of the valve mechanism 20 (not detailed), the open network of the internal storage structure created by the support network between the front 24 and back 22 panels, the front panel 24 and the area 34 of panel 24 where it is deformed to produce a button shape. FIG. 2b shows a close-up view of the deformed area 26 in which it is clear that after depression of button 26, structural stress will serve to make the button 26 try to regain its former shape. In a preferred embodiment button 26 is dome shaped.

In a further preferred embodiment said button is produced by thermoforming.

Referring now to FIGS. 3a and 3b, a preferred embodiment of the spine 28 is shown, illustrating how an open volume 30 enabling free flow of liquid within is maintained, while providing good structural support to the front 24 and back 22 panels. Advantageously, by providing said structural support as an integral part of the injection-molded plastic spine 28, the thickness of the front and back panels 24, 22 can be kept at a minimum, thereby reducing the overall cost of components. Furthermore, it is this approach which enables a liquid-containing dispenser to be fabricated as a rigid container while enabling dimensions under 3 mm thick, similar to a credit card. Typically, the dispenser can support a spread load greater than 7800 N/square meter.

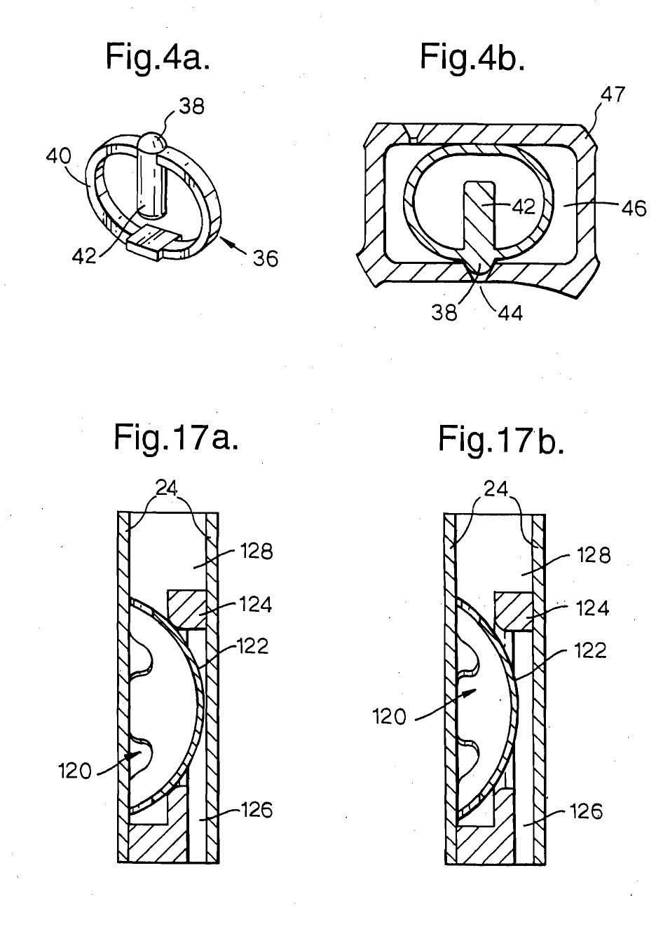

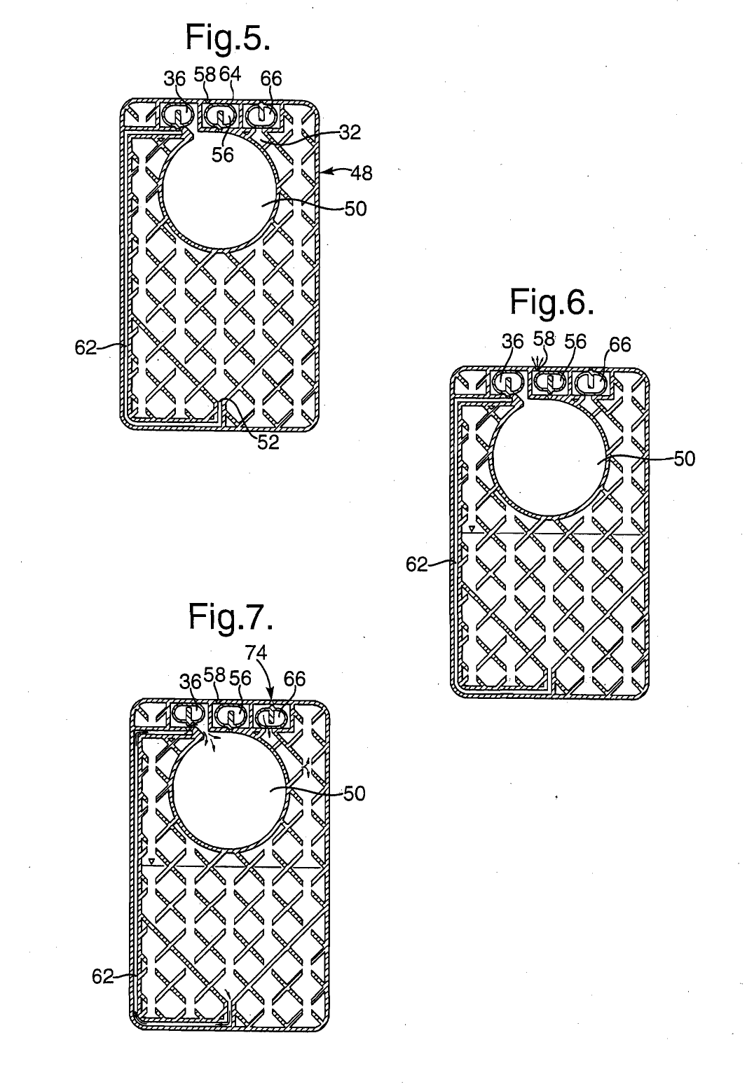

Referring now to FIG. 4, a preferred embodiment of a valve created as an injection-molded part is shown. FIG. 4a shows a ring-shaped valve 36 consisting of a spring section 40, which can be compressed into a more oval shape and a plunger component 42 with a ball-shaped end 38. FIG. 4b shows this part located within a chamber 46 with an orifice 44 in the valve wall 47 into which the ball-shaped end 38 of the plunger 42 fits when blocking off the flow. This type of valve is utilized within the three-valve mechanism illustrated in FIG. 5 below.

Referring now to FIG. 5, a description of the all of the mechanical parts of a preferred embodiment of the dispensing package 48 of the current invention can be given. The pumping chamber 50 is the enclosed volume under the button 26. The liquid intake into this chamber 50 of the liquid to be dispensed is channeled from the one end of the dispensing package 52 via a conduit 62 to a liquid intake valve 36. The expulsion of first, air, and subsequently, when the pumping chamber 50 is full of liquid, the liquid, takes place through the outlet valve 56 and nozzle 58 shown. The pressure-compensation valve 66 opens as a function of low pressure created within the air space 32 above the level of the liquid contents of the dispenser.

Turning now to FIG. 6, on depression of the button 26, seen in FIG. 2a, and therefore the creation of pressure in the chamber 50, the outlet valve 56 is forced open and (initially) air expelled via it through the nozzle 58. Once the chamber 50 is filled with liquid, it is this liquid that will be expelled from the nozzle 58 on each depression. In an alternative embodiment (not shown), a further conduit will be built in to the structure of the internal partitions within the dispenser such that the liquid will be discharged from the base of the chamber 50 rather than the part nearest the outlet valve nozzle 64.

Referring now to FIG. 7, the result of releasing the button 26 is shown. Due to structural stress to return the button to its starting position (i.e. fully extended), low pressure is created in the chamber 50, resulting in the opening of the inlet valve 36 causing (a) liquid to be drawn through conduit 62 into the chamber 50, and (b) causing pressure-compensation valve 66 to open so that air can enter via the air inlet 74.

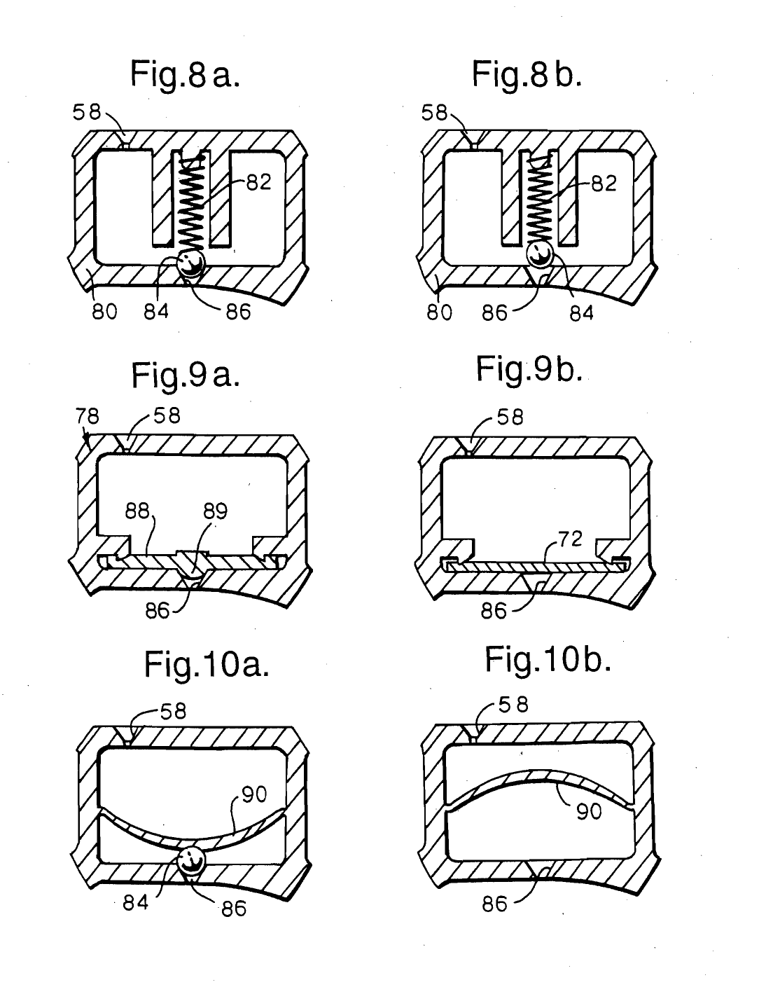

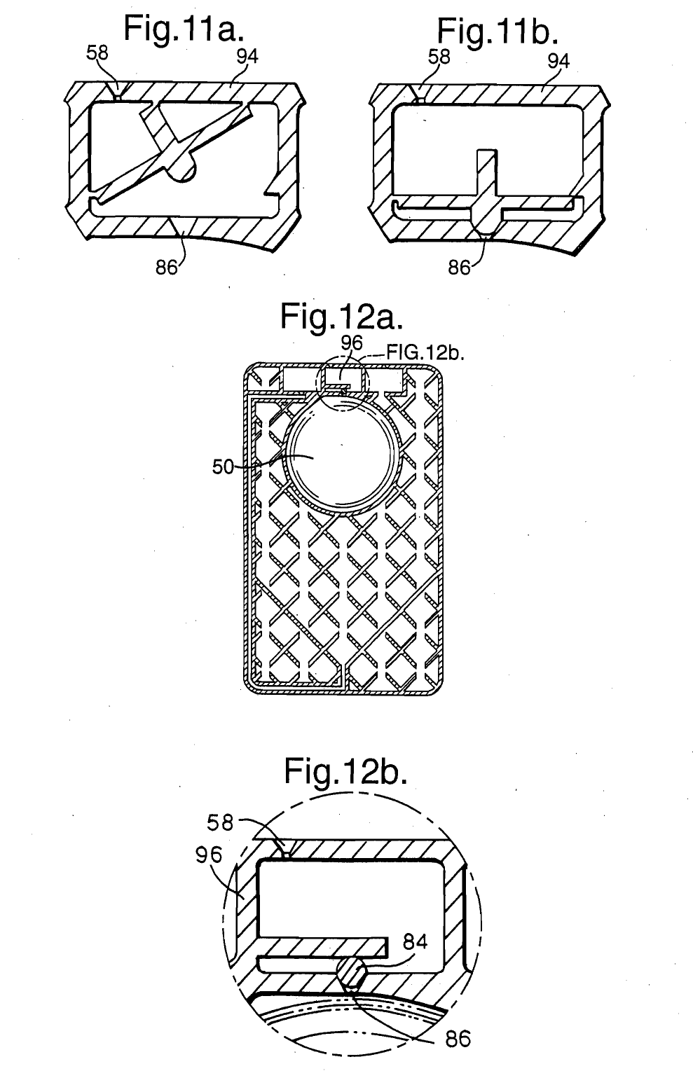

As will be apparent to one skilled in the art, a number of alternative embodiments of the valve mechanism utilized are possible. In this context, FIG. 8a shows a closed valve 80 comprising a spring 82 and ball 84 mechanism, where FIG. 8b shows this mechanism in an open state such that the outlet 86 is opened. Likewise, FIG. 9 illustrates a valve mechanism 78 based on rubber or rubberized strips 88, where FIG. 9a illustrates such a strip with a ball shape 89 in the middle, and FIG. 9b shows a flat configuration 72. Similarly, FIG. 10a shows a spring 90 and ball 84 implementation of a valve as an injection-molded part, where FIG. 10b shows the preferred orientation of the spring during injection molding. As an alternative embodiment, FIG. 11 illustrates a simple one-piece plastic valve 94, showing its molding position in FIG. 11a, and its set position after assembly in FIG. 11b. Lastly, a cantilevered valve 96 is shown in FIG. 12b, where FIG. 12a illustrates this type of valve replacing that used in FIGS. 5 through 7 for the outlet valve.

In general, in the embodiments of the present invention, the valve consists of a sealing surface around the inlet, a sealing element and a loading means that makes the two surfaces seal against each other; such that when the liquid builds up pressure beyond a certain predetermined threshold, the loading means will deform, thereby allowing the two surfaces to separate from each other and allow liquid flow through the valve. As pressure builds up in the opposite direction to that of the valve flow, said pressure will support the loading means in forcing the sealing element against the sealing surface. The loading element may be made of plastic, rubber or metal such as steel. The sealing element may be made of plastic, rubber, metal such as steel, ceramic or a combination of these. The inlet and the sealing surface around the inlet maybe part of the spine. Alternatively, the inlet and the sealing surface around the inlet may constitute a separate part attached to the spine, and be made of plastic, metal, rubber, ceramics or a composite of these materials. The sealing element may be one part with the loading means. The sealing element may be part of the spine. The loading means is a spring made of plastic or metal. Said spring can be a cantilever spring or a leaf spring or a compression coil spring or a torque coil spring or a dome spring or a stressed rubber component. The loading element may be a single part with the spine and/or the sealing element. Where the spring is a compression coil spring, the sealing element may be a ball or a component with a rounded end. The spring action of the valve can be either parallel or perpendicular to the flow of the product through it.

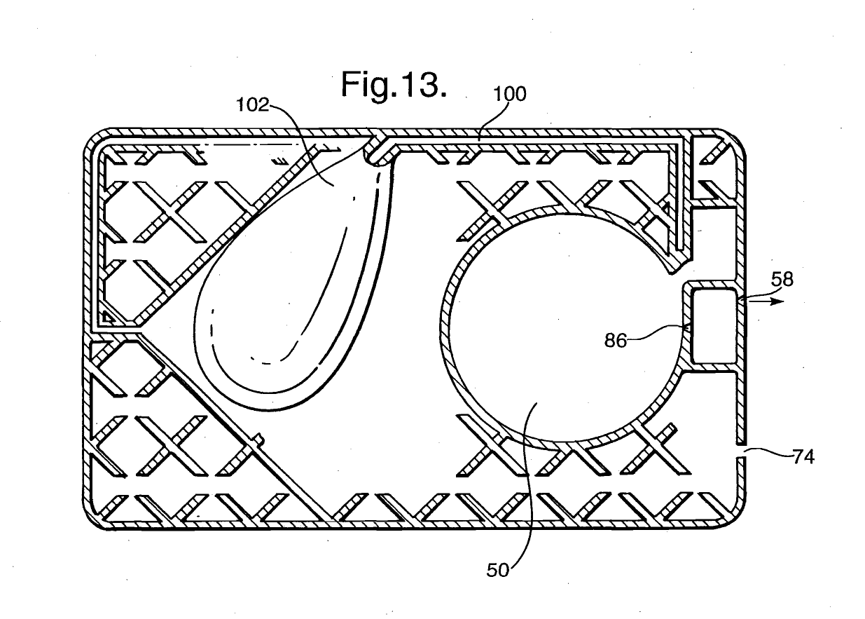

Although all embodiments described until this point employed three valves, it is also possible and in some cases preferable to use only two valves. An example would be when the liquid to be dispensed has a high viscosity, for example toothpaste. Referring now to FIG. 13, the pressure-compensation valve 66 that appeared in FIGS. 5-7 is now obviated, although the air inlet 74 is still required. In the present embodiment, the conduit 100 is connected to a bag 102, which contracts as the liquid is pumped.

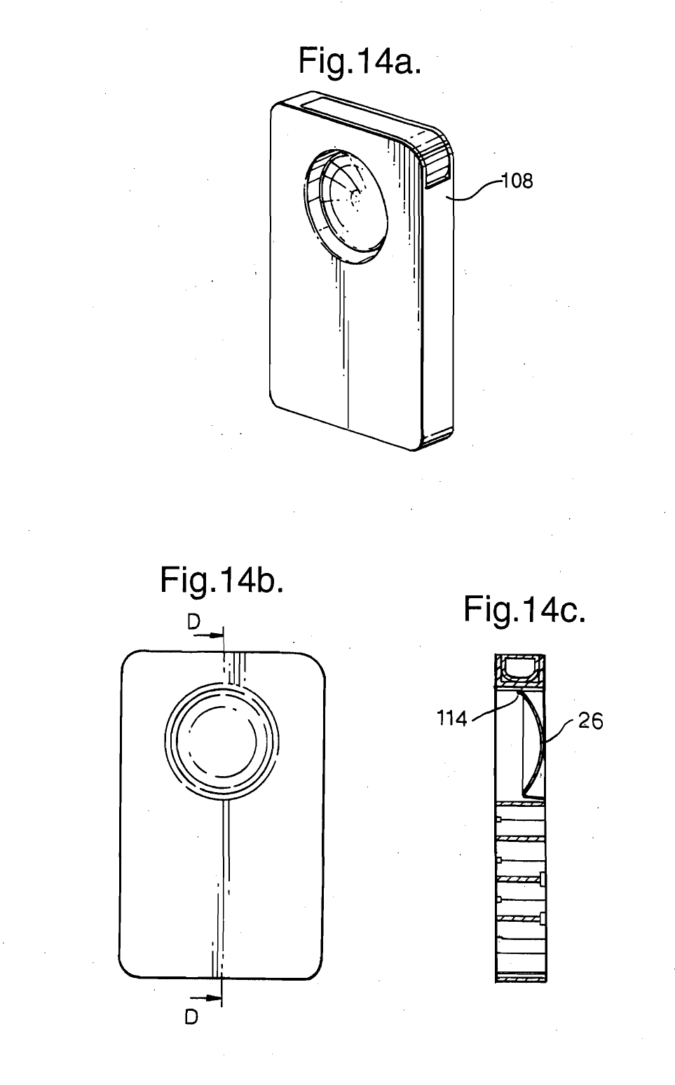

Although the above embodiments described a form factor similar to that of a credit card, it will be clear that the dispensing closure of the present invention is equally applicable to further form factors. For example, FIGS. 14a, b & c illustrate a further preferred embodiment of the dispensing package 104 according to the present invention, where the pumping button 26 is as before, but the width of the side panel 108 implemented as part of the injection-molded part or spine is considerably taller than in the embodiments discussed above. Typical package widths for the deep form dispenser can be expected to range from approximately 1 cm to approximately 5 cm. Typical applications will include condiments such as ketchup and other dressings, and personal care items such as liquid soaps and shampoos.

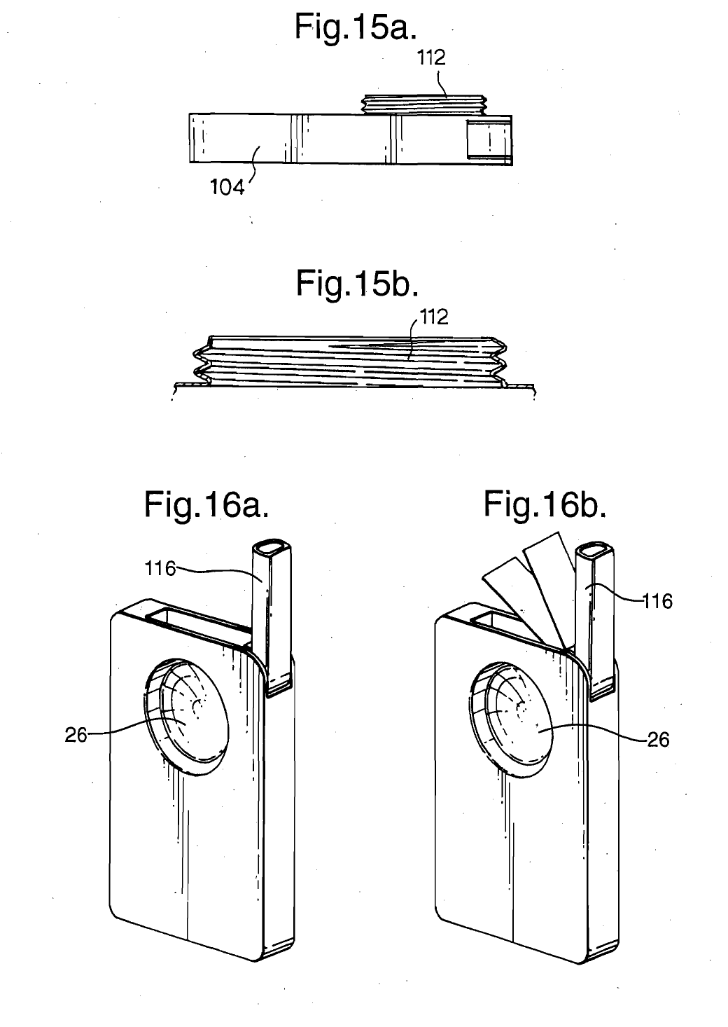

A number of alternative embodiments of button mechanisms for the dispensing enclosure are possible, including plungers supported by a spring (not shown) and a bellows-type button 112 shown in FIGS. 15a & b, which is shown inset into the deep form-factor dispenser discussed above.

As will be obvious to those skilled in the art, a number of alternative embodiments exist also for the nozzle part of the dispenser, including but not limited to such structures as needle and catheter-type nozzles. FIGS. 16a and 16b illustrate a foldout nozzle 116, which is connected to the outlet valve 114 seen in FIG. 14c. The present embodiment is advantageous for food applications where direction of the condiment (for example) to a specific point is important. A further advantage of this embodiment is that the nozzle can include an additional cut-off valve, which is operative in the closed position when the nozzle is folded away, providing an extra safety feature.

FIGS. 17a and 17b show an embodiment of a valve 120 constructed to operate by movement of an arcuate sealing element 122 in a direction perpendicular to spaced-apart major surfaces 24. The valve is normally closed, as seen in FIG. 17a; the sealing element 122 is in contact with a fixed valve seat 124 to complete the seal.

When liquid pressure in the input port 126 rises beyond a pre-determined threshold, the sealing element 122 is slightly deformed, separates from the seat 124 and allows liquid to pass through the outlet port 128.

In addition, it is possible to provide a duplication of the mechanism within a single device such that it could contain for example, two parallel mechanisms, e.g., one for oil and one for vinegar for making a salad dressing or two separate chemicals for a medical diagnostic, etc.

The preferred materials for the front and back panels are plastics or metals, where a multi-layer plastic sheet or foil, with a metal layer such as aluminum, is a preferred embodiment. This is advantageous as a material providing good barrier characteristics and therefore can keep oxygen out, while preventing leakage of or interaction with the liquid contents.

The invention can be configured to dispense small quantities of liquids such as, for example, a perfume, an eau de toilet, a breath freshener, a shampoo, a liquid soap, a shaving gel, a hair conditioner, a comestible substance, snuff, an inhalable medicine, an oil, and mace.

The invention can further be configured to incorporate a magnetic strip and an integrated circuit. An electronic clock or counter may be used to implement an automatic shut-off mechanism which is useful for example to ensure that drugs are taken at a specific time interval; or to prevent use of a food substance such as mayonnaise which has passed its expiry date.

In yet a further embodiment of the invention a plurality of substances is held in the dispenser, each in its own chamber. Said substances can be selectively dispensed separately or together or caused to mix prior to dispensing by means of an appropriate manually-operated valve.

In yet a further embodiment of the invention the pumping button can protected by a rigid safety cover which is slid or otherwise moved aside when the device is to be used.

Also, the invention can be configured to include various manually activated valves, including: (a) a valve between the pumping chamber and the nozzle, (b) a valve between the liquid contents and the pumping mechanism, and (c) a safety valve, which cannot be operated by a young child.

While the invention has been shown herein in what is presently conceived to be the most practical and preferred embodiment thereof, it will be apparent to those of ordinary skill in the art that many modifications may be made thereof within the scope of the invention, which scope is to be accorded the broadest interpretation of the appended claims so as to encompass all equivalent structures and devices.

1.-47. (canceled)

48. A liquid dispenser comprising a mostly rigid body including two spaced-apart generally flat, parallel major front and back panel surfaces having interconnected peripheral edges to delimit therebetween a closed dispensing body having a liquid to be dispensed contained therein, a pumping chamber having an inlet valve and a non-return product dispensing valve and actuated by a pumping button provided along one of said major surfaces and displaceable between a first normal position and a second depressed position, the arrangement being such that said pumping chamber is directly bounded by said two spaced-apart surfaces and said dispenser is formed as a compact, self-contained unitary container and pump, characterized in that said pumping button is formed as an integral part of one of said major surfaces and serves as a wall of said pumping chamber and depression of the pumping button to its displaced position causes liquid contained in said pumping chamber to be expelled via said product dispensing valve, and return of said button to its first normal position causes liquid to enter said pumping chamber via said inlet valve and further comprising a non-return pressure-compensation valve leading into said body.

49. A liquid dispenser according to claim 48, further comprising an uptake conduit in fluid communication with said inlet valve and positioned to deliver liquid to said pumping chamber upon return of said pumping button to its first pumping position.

50. A liquid dispenser according to claim 48, wherein return of said button to its first normal position transfers said liquid from said uptake conduit to said pumping chamber which, in turn, forces liquid from said body into said uptake tube and causes air to enter said body via said pressure-compression valve.

51. A liquid dispenser according to claim 49, wherein return of said button to its first normal position transfers said liquid from said uptake conduit to said pumping chamber which, in turn, forces liquid from said body into said uptake tube and causes air to enter said body via said pressure-compression valve.

52. A liquid dispenser according to claim 48, wherein said pumping button is inset into one of said major surfaces.

53. A liquid dispenser according to claim 48, wherein said dispenser comprises an injection-molded plastic part disposed between said front and back panel surfaces, where said liquid contents are stored in spaces provided in said injection-molded part.

54. A liquid dispenser according to claim 53, wherein said injection-molded part serves as a spine of said dispenser supporting said panels, thereby providing structural strength to said dispenser.

55. A liquid dispenser according to claim 48, wherein said dispenser further comprises a nozzle in fluid communication with said non-return product dispensing valve.

56. A liquid dispenser according to claim 55, wherein said nozzle is a spray nozzle.

57. A liquid dispenser according to claim 55, wherein said nozzle can be swiveled to extend away from the dispenser.

58. A liquid dispenser according to claim 48, wherein at least part of said valves is an integral component of said injection-molded plastic part.

59. A liquid dispenser according to claim 54, wherein at least part of said panels is an integral component of said injection-molded plastic part.

60. A liquid dispenser according to claim 48, wherein said button has an initial and a depressed position, where after depression, said button is able to return to its initial position due to air inflow via said non-return pressure-compensation valve leading into said body from the atmosphere.

61. A liquid dispenser according to claim 48, wherein said button is fabricated by thermoforming part of one of said panels into a button shape which can be depressed and on release is urged to return to its first normal position.

62. A liquid dispenser according to claim 48, wherein said dispenser is shaped and said major surfaces are sized similar to a shape and size of a credit card.

63. A liquid dispenser according to claim 48, wherein the thickness of said dispenser is under 3 mm.

64. A liquid dispenser according to claim 48, wherein said dispenser incorporates a magnetic strip attached to one of said major surfaces configured to match those on credit cards and electronic entry keys and further incorporates an integrated circuit.

65. A liquid dispenser according to claim 53, wherein said side panels are made of materials including: plastic, electroplated plastic, laminated materials and metal sheet.

66. A liquid dispenser according to claim 48, wherein said dispenser can support a spread load greater than 7,800 N/square metre.

67. A liquid dispenser according to claim 48, wherein said liquid is one of the group comprising a perfume, an eau de toilette, a breath freshener, a shampoo, a liquid soap, a shaving gel, a hair conditioner, a comestible substance, snuff, an inhalable medicine, an oil, and mace.

68. A liquid dispenser according to claim 48, further comprising a rigid safety cover which is moved aside when the device is to be used.

69. A liquid dispenser according to claim 48, further provided with a manually actuated safety valve which cannot be operated by a young child.

70. A liquid dispenser according to claim 48, wherein at least part of said valves is constructed to operate by movement of a sealing element in a direction perpendicular to said spaced-apart major surfaces.

71. A liquid dispenser according to claim 54, wherein said major surfaces are fabricated as one contiguous surface surrounding the spine.

72. A liquid dispenser according to claim 48, wherein said inlet valve is a non-return inlet valve.
